(19) United States
(12) Patent Application Publication
(10) Pub. No.: US 2025/0370915 A1
(43) Pub. Date: Dec. 4, 2025

(54) SYSTEMS AND METHODS FOR AUTOMATED SOFTWARE TESTING

(71) Applicant: WORKDAY, INC., Pleasanton, CA (US)

(72) Inventors: Allan FARROW, Castro Valley, CA (US); Scott STANLEY, Hayward, CA (US)

(21) Appl. No.: 18/679,133

(22) Filed: May 30, 2024

(51) Int. Cl. G06F 11/36

(52) U.S. Cl. CPC G06F 11/3688; G06F 11/3684

(57) ABSTRACT

In some implementations, the techniques described herein relate to a method including: executing, by a processor on a collection of source code, a test suite comprising a plurality of tests; clustering, by the processor based on a result of executing the test suite, the plurality of tests into a plurality of test clusters; designating, by the processor for a particular test cluster within the plurality of test clusters, a cluster-representative test; and executing, by the processor on a subsequent collection of source code, a culled test suite, the culled test suite comprising a subset of the plurality of tests including the particular test cluster's cluster-representative test.

### BACKGROUND

Software development is a dynamic process characterized by continuous changes to source code. These changes can inadvertently introduce errors, compromising the integrity and stability of the source code. Software testing tools can help to guard against such errors. Some tools perform a range of functions aimed at preserving the integrity and reliability of evolving source code, including impact assessment, risk analysis, and dependency mapping. Software testing tools can allow development teams to identify and address potential issues, ensuring the robustness and resilience of software throughout its lifecycle.

### BRIEF DESCRIPTION OF THE FIGURES

FIG. 1 is a block diagram illustrating a code management system configured to identify negative impacts triggered by changes to source code according to some embodiments of the disclosure.

FIG. 2 is a block diagram illustrating a test clustering system configured to cluster the tests of a test suite into multiple clusters according to some embodiments of the disclosure.

FIG. 3 is a flow diagram illustrating a method for clustering tests within a test suite according to some embodiments of the disclosure.

FIG. 4 is a flow diagram illustrating a method for executing a culled test suite on source code according to some embodiments of the disclosure.

FIG. 5 is a flow diagram illustrating an exemplary process in which both a full test set and a culled test set are used at different times according to some embodiments of the disclosure.

FIG. 6 is a block diagram of a computing device according to some embodiments of the disclosure.

### DETAILED DESCRIPTION

The disclosed embodiments relate to testing modified source code for errors. In some examples, the disclosed embodiments describe techniques for selecting a set of tests to apply to modified source code (e.g., a culled set of tests selected from a larger suite of tests based on a similarity analysis that predicts a similarity between the tests of the larger suite of tests). The selected set of tests can, in some examples, be used to provide developers with quick feedback (e.g., for incremental changes made to source code throughout the day). In some examples, the disclosed embodiments use a statistical learning approach to test selection (e.g., in contrast to a mechanistic approach), reducing the number of tests used to provide feedback for modified source code.

In some implementations, the techniques described herein relate to a method including: executing, by a processor on a collection of source code, a test suite including a plurality of tests; clustering, by the processor based on a result of executing the test suite, the plurality of tests into a plurality of test clusters; designating, by the processor for a particular test cluster within the plurality of test clusters, a cluster-representative test; and executing, by the processor on a subsequent collection of source code, a culled test suite, the culled test suite comprising a subset of the plurality of tests including the particular test cluster's cluster-representative test.

In some implementations, the techniques described herein relate to a method, wherein: the collection of source code includes a plurality of versions of the collection of source code, each of which is captured at a different interval within a designated window of time; and executing the test suite on the collection of source code includes executing the test suite on each version within the plurality of versions.

In some implementations, the techniques described herein relate to a method, wherein clustering the plurality of tests into the plurality of test clusters includes clustering the plurality of tests based on a similarity metric quantifying a similarity between the plurality of tests.

In some implementations, the techniques described herein relate to a method, wherein the similarity quantified by the similarity metric relates to co-variance between execution statuses of the plurality of tests when executed across the plurality of versions of the collection of source code.

In some implementations, the techniques described herein relate to a method, further including selecting, by the processor, a test to be designated as the particular test cluster's cluster-representative test, wherein selecting the test includes: identifying the test as a centroid of the particular test cluster; and selecting the test as the cluster-representative for the particular test cluster in response to identifying the test as the centroid of the particular test cluster.

In some implementations, the techniques described herein relate to a method, wherein: the subsequent collection of source code includes a base code and one or more changes applied to the base code; and executing the culled test suite on the subsequent collection of source code includes: generating a list of tests relating to areas of the base code predicted to be affected by the one or more changes applied to the base code; determining, for each test within the list of tests, a cluster corresponding to the test; and configuring the culled test suite to include, for each determined cluster, a cluster-representative test selected for the determined cluster and to exclude, for each determined cluster, one or more tests that were not selected as the cluster-representative test for the determined cluster.

In some implementations, the techniques described herein relate to a method, wherein generating the list of tests relating to the areas of the base code predicted to be affected by the one or more changes includes: applying the subsequent collection of source code as input to an impact analysis tool; and generating the list of tests based on an output from the impact analysis tool.

In some implementations, the techniques described herein relate to a method, further including: determining, by the processor, that applying the culled test suite to the subsequent collection of source code did not yield any test failures; merging, by the processor, the subsequent collection of source code, including the base code and the one or more changes to the base code, with an additional subsequent collection of source code, wherein the additional subsequent collection of source code includes the base code and one or more additional proposed changes to the base code; executing, by the processor, an additional culled test suite to the merged collection of source code; determining, by the processor, that applying the additional culled test suite to the merged collection of source code yielded one or more test failures; and in response to determining that executing the culled test suite to the subsequent collection of source code did not yield any test failures and that applying the additional culled test suite to the merged collection of source code yielded one or more test failures, determining, by the processor, that a conflict exists between the one or more proposed changes to the base code and the one or more additional proposed changes to the base code.

In some implementations, the techniques described herein relate to a non-transitory computer-readable storage medium for tangibly storing computer program instructions capable of being executed by a computer processor, the computer program instructions defining steps of: executing, by a processor on a collection of source code, a test suite including a plurality of tests; clustering, by the processor based on a result of executing the test suite, the plurality of tests into a plurality of test clusters; designating, by the processor for a particular test cluster within the plurality of test clusters, a cluster-representative test; and executing, by the processor on a subsequent collection of source code, a culled test suite, the culled test suite comprising a subset of the plurality of tests including the particular test cluster's cluster-representative test.

In some implementations, the techniques described herein relate to a non-transitory computer-readable storage medium, wherein: the collection of source code includes a plurality of versions of the collection of source code, each of which is captured at a different interval within a designated window of time; and executing the test suite on the collection of source code includes executing the test suite on each version within the plurality of versions.

In some implementations, the techniques described herein relate to a non-transitory computer-readable storage medium, wherein clustering the plurality of tests into the plurality of test clusters includes clustering the plurality of tests based on a similarity metric quantifying a similarity between the plurality of tests.

In some implementations, the techniques described herein relate to a non-transitory computer-readable storage medium, wherein the similarity quantified by the similarity metric relates to co-variance between execution statuses of the plurality of tests when executed across the plurality of versions of the collection of source code.

In some implementations, the techniques described herein relate to a non-transitory computer-readable storage medium, the computer program instructions further defining a step of selecting, by the processor, a test to be designated as the particular test cluster's cluster-representative test, wherein selecting the test includes: identifying the test as a centroid of the particular test cluster; and selecting the test as the cluster-representative for the particular test cluster in response to identifying the test as the centroid of the particular test cluster.

In some implementations, the techniques described herein relate to a non-transitory computer-readable storage medium, wherein: the subsequent collection of source code includes a base code and one or more changes applied to the base code; and executing the culled test suite on the subsequent collection of source code includes: generating a list of tests relating to areas of the base code predicted to be affected by the one or more changes applied to the base code; determining, for each test within the list of tests, a cluster corresponding to the test; and configuring the culled test suite to include, for each determined cluster, a cluster-representative test selected for the determined cluster and to exclude, for each determined cluster, one or more tests that were not selected as the cluster-representative test for the determined cluster.

In some implementations, the techniques described herein relate to a non-transitory computer-readable storage medium, wherein generating the list of tests relating to the areas of the base code predicted to be affected by the one or more changes includes: applying the subsequent collection of source code as input to an impact analysis tool; and generating the list of tests based on an output from the impact analysis tool.

In some implementations, the techniques described herein relate to a non-transitory computer-readable storage medium, the computer program instructions further defining the steps of: determining, by the processor, that applying the culled test suite to the subsequent collection of source code did not yield any test failures; merging, by the processor, the subsequent collection of source code, including the base code and the one or more changes to the base code, with an additional subsequent collection of source code, wherein the additional subsequent collection of source code includes the base code and one or more additional proposed changes to the base code; executing, by the processor, an additional culled test suite to the merged collection of source code; determining, by the processor, that applying the additional culled test suite to the merged collection of source code yielded one or more test failures; and in response to determining that executing the culled test suite to the subsequent collection of source code did not yield any test failures and that applying the additional culled test suite to the merged collection of source code yielded one or more test failures, determining, by the processor, that a conflict exists between the one or more proposed changes to the base code and the one or more additional proposed changes to the base code.

In some implementations, the techniques described herein relate to a device including: a processor; and a storage medium for tangibly storing thereon program logic for execution by the processor, the program logic including: logic, executed by the processor, for executing a test suite including a plurality of tests, logic, executed by the processor, for clustering, based on a result of executing the test suite, the plurality of tests into a plurality of test clusters, logic, executed by the processor, for designating, for a particular test cluster within the plurality of test clusters, a cluster-representative test, and logic, executed by the processor, for executing, on a subsequent collection of source code, a culled test suite that includes the particular test cluster's cluster-representative test and that excludes one or more tests of the particular test cluster that were not designated as the particular test cluster's cluster-representative test.

In some implementations, the techniques described herein relate to a device, wherein: the collection of source code includes a plurality of versions of the collection of source code, each of which is captured at a different interval within a designated window of time; and executing the test suite on the collection of source code includes executing the test suite on each version within the plurality of versions.

In some implementations, the techniques described herein relate to a device, wherein clustering the plurality of tests into the plurality of test clusters includes clustering the plurality of tests based on a similarity metric quantifying a similarity between the plurality of tests.

In some implementations, the techniques described herein relate to a device, wherein the similarity quantified by the similarity metric relates to co-variance between execution statuses of the plurality of tests when executed across the plurality of versions of the collection of source code.

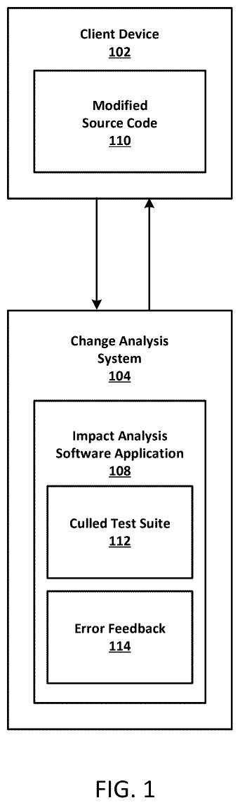

FIG. 1 is a block diagram illustrating a code management system for identifying negative impacts caused by changes to source code, according to some of the disclosed embodiments.

As illustrated, a code management system includes a client device 102, a change analysis system 104, and an impact analysis software application 108.

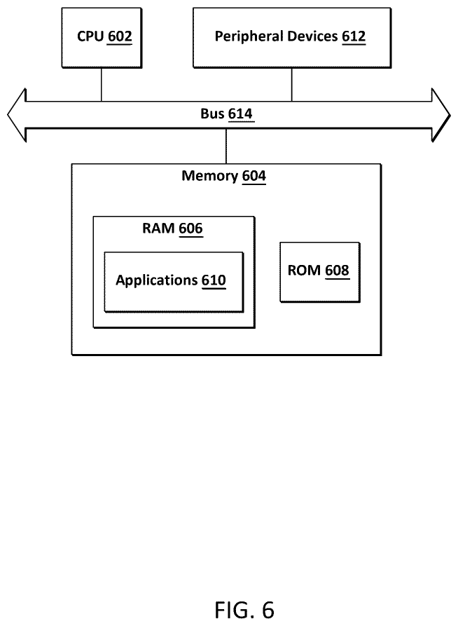

In the illustrated system, client device 102 may comprise a computing device communicatively coupled to change analysis system 104. Examples of computing devices are described in the description of FIG. 6 and that description is not repeated herein but is incorporated in its entirety. As one example, client device 102 may include a laptop or desktop computing device. As another example, client device 102 may include a mobile phone or a tablet computing device. In general, client device 102 can comprise any computing device that can receive and/or execute a software application. In some examples, client device 102 can comprise a computing device used by a software developer to make changes to source code. Change analysis system 104 may comprise any type or form of computing device (e.g., as described in connection with FIG. 6) that performs functions directed at managing code development (e.g., testing for coding errors). In some examples, change analysis system 104 may be implemented on a server computing device.

In the following description, client device 102 is described as a computing device that communicates over a network with impact analysis software application 108, via change analysis system 104. For example, impact analysis software application 108 can comprise a software-as-a-service (SaaS) application, and client device 102 may comprise a personal computing device accessing the software application via a web browser or dedicated mobile app. In the illustrated system, impact analysis software application 108 operates within change analysis system 104. In other examples, impact analysis software application 108 can be installed directly on client device 102.

As illustrated in FIG. 1, client device 102 can submit (e.g., upload) modified source code 110 to impact analysis software application 108. In general, modified source code 110 refers to base code combined with one or more changes (e.g., proposed changes) made, for example, by client device 102, to the base code. In some examples, modified source code 110 may correspond to any entire codebase. In other examples, modified source code 110 may correspond to a portion of a codebase (e.g., one or more lines of code to which a developer associated with client device 102 has made changes). In yet other examples, modified source code 110 may comprise a “diff” file or other representation only of changes to the base source code. In some examples, the changes to modified source code 110 may be delineated in modified source code 110 and/or in association with modified source code 110 (e.g., via a changing tracking mechanism of a code development environment, a change log, diff, etc.).

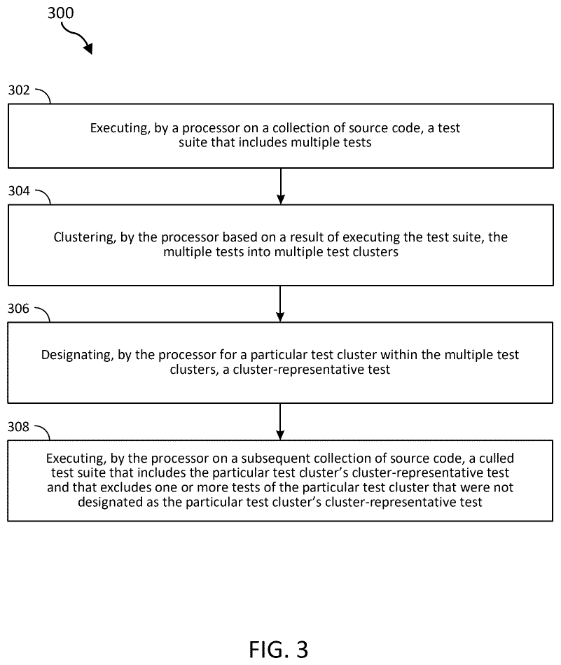

Upon receiving modified source code 110, impact analysis software application 108 can execute a culled test suite 112 on modified source code 110 (e.g., by executing each test within culled test suite 112 on modified source code 110). Further detail of this process is described in more detail in, for example, step 308 of FIG. 3.

In some implementations, culled test suite 112 may represent a culled set of software tests selected from a larger suite of software tests (e.g., a subset of the tests included in the larger suite of tests) (not illustrated). A software test can refer to any type or form of systematic computer-implemented procedure, or set of procedures, configured to assess the behavior, functionality, and/or performance of source code when executed on the source code. In the various implementations, software tests may be defined using any software testing framework or language (e.g., JUnit, RSpec, Jest, Cucumber, etc.) and the specific implementation of a testing framework is not intended to be limiting.

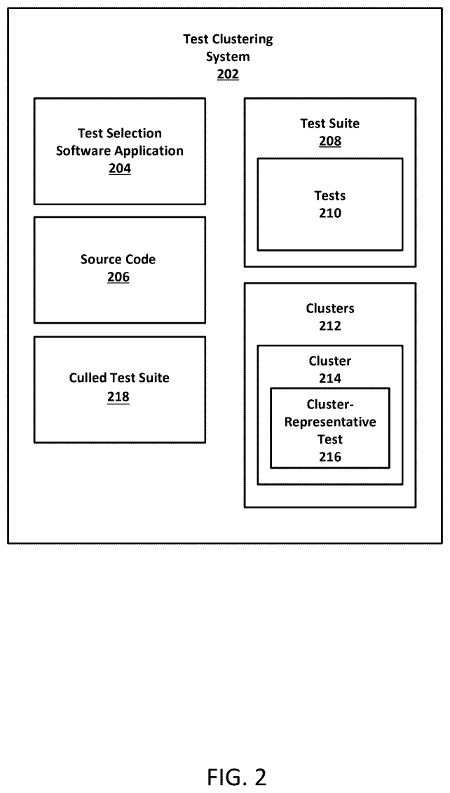

In some examples, a software test may be configured to pass (e.g., if no errors are detected) or fail (e.g., if an error is detected). In some examples, the culled tests from the larger suite of tests may have been clustered into multiple clusters of correlated tests (e.g., clustering according to a similarity metric). A detailed description of this clustering process is described in connection with FIG. 2 and that description is not repeated herein but is incorporated in its entirety. In these examples, impact analysis software application 108 can select which tests, from the larger suite of tests, to include in culled test suite 112 using the clusters of the larger suite of tests. In some such examples (as will be described in connection with FIG. 2), some or all tests may be clustered based on historical correlations between testing outcomes of the tests. Thus, in some examples, by using the clusters to select tests for a culled test suite, the disclosed framework may select tests (to be applied to a modified source code) based on correlations between testing outcomes (e.g., instead of, or in addition to, selecting tests based on functionalities associated with the modifications of the modified source code). In this manner, a subset of a test suite may be specifically selected based on outcomes and run faster than an entire test suite.

As one example, impact analysis software application 108 can configure culled test suite 112 as a tailored test suite, customized for modified source code 110, by first generating a list of tests relating to areas of the base code predicted to be affected by the changes applied to the base code in modified source code 110. Impact analysis software application 108 can generate this list in a variety of ways (e.g., based on data from a database of code dependencies, output from a test-identification model such as an impact analysis tool, user input, etc.). Next, impact analysis software application 108 can determine, for each test within the list of tests, a cluster (from the multiple clusters of the larger suite of tests) that the test falls within. Finally, change analysis system 104 can configure culled test suite 112 to (1) include, for each determined cluster, a cluster-representative test selected for the determined cluster and (2) exclude, for each determined cluster, one or more tests (e.g., each of the tests) that were not selected as the cluster-representative test for the determined cluster. (Systems and methods for generating the cluster-representative test for each determined cluster will be discussed in greater detail below in connection with FIG. 2 and that description is not repeated herein but is incorporated in its entirety).

In other examples, culled test suite 112 may represent a general test suite (e.g., as opposed to a customized test suite). In some such examples, impact analysis software application 108 can configure culled test suite 112 by (1) clustering a larger suite of tests (e.g., a complete suite) into multiple clusters (e.g., as will be described in connection with FIGS. 2) and (2) only including in culled test suite 112, from the larger suite of tests, a designated number of cluster-representative tests from each of the clusters (e.g., only including a single cluster-representative test for each cluster).

After executing culled test suite 112, based on a result of the executing, impact analysis software application 108 may identify the tests that passed and the tests that failed and generate error feedback 114. Error feedback 114 may include a variety of content. Such content may include, without limitation, an indication of specific tests that failed, an indication that no tests failed, an error message indicating a nature of a failure (an assertion error, a timeout, etc.), etc.

By culling the larger suite of tests (e.g., from each test in the initial list of tests down to a suite that only includes a cluster-representative test for each of multiple clusters), impact analysis software application 108 may generate and/or execute a test set that is much more time and resource effective (e.g., without compromising efficacy). In some examples, impact analysis software application 108 may represent a framework that (1) applies modified source code to a first impact analysis tool (e.g., a tool configured to identify all tests relating to areas of base code that may be impacted by a change to the base code), (2) applies an output from the first impact analysis tool (e.g., all tests identified by the first impact analysis tool) to a second impact analysis tool (e.g., a tool configured to cull the tests identified by the first impact analysis tool based on clustering data), and then (3) executes an output from the second impact analysis tool (e.g., the culled set of tests identified by the second impact analysis tool) on the modified source code to determine potential errors based on test-failure data.

In certain examples, impact analysis software application 108 may determine that executing a test suite (e.g., culled test suite 112) on modified source code 110 did not yield any test failures. After making this determination, impact analysis software application 108 may (1) merge modified source code 110 with another modified source code (e.g., which includes changes made during a same time period as, or at a later time period than, the time period during which the changes were made to modified source code 110) and (2) execute the test suite (e.g., culled test suite 112) on the merged source code. In these examples, impact analysis software application 108 may determine that executing the test suite on the merged source code yielded one or more test failures. Based on determining that (1) executing the test suit on modified source code 110 did not yield any failure and (2) executing the test suit on the merged source code did yield one or more test failures, impact analysis software application 108 may determine that a conflict exists between modified source code 110 and the other modified source code. This determination may trigger a variety of actions (e.g., triggering an alert to be transmitted to a developer, a report, a digital visual representation of the conflict, etc.).

FIG. 2 is a block diagram illustrating a test clustering system 202, configured to cluster the tests of a test suite into multiple clusters, according to some of the disclosed embodiments. As illustrated in FIG. 2, test clustering system 202 can include a test selection software application 204.

In some examples, test selection software application 204 can execute, on a collection of source code 206, a test suite 208 that includes multiple tests 210 configured for testing software (e.g., as described at step 302 of FIG. 3). Source code 206 may represent any type or form of code. In some examples, source code 206 may represent an entire codebase (e.g., all source code and other resources corresponding to a software project and/or application). Test suite 208 may represent a collection of software tests configured to identify errors generated by changes made to code. In some examples, test suite 208 may represent a collection of tests used by an impact analysis tool.

In some examples, source code 206 may include multiple versions of source code, each of which is captured at a different interval within a designated window of time (e.g., a daily capture of source code 206 captured over the past week). In these examples, test selection software application 204 can execute test suite 208 on source code 206 by executing test suite 208 on each of these versions.

Based on a result of executing test suite 208 (e.g., a result yielded by executing test suite 208 on each version of source code 206), test selection software application 204 can cluster tests 210 into multiple test clusters 212 (e.g., including cluster 214) (e.g., as described at step 304 of FIG. 3). Test selection software application 204 can cluster tests 210 in a variety of ways. In some examples, test selection software application 204 can cluster tests 210 based on a similarity metric quantifying a similarity between tests 210. In one example, this similarity may relate to co-variance between execution statuses (e.g., failure statuses) of tests 210 when executed across the multiple versions of source code 206. For example, correlated tests (e.g., tests that fail together above a threshold amount) may be clustered together. In some examples, tests 210 may be clustered using a coefficient (e.g., a Jaccard similarity coefficient) measuring an amount (e.g., a size) of intersection between the execution statuses of the tests within tests 210. For example, for each given test within tests 210, a coefficient may be generated denoting the intersection between execution statuses of the given test (across multiple versions of source code 206) and the execution statuses of each of the other tests within tests 210 (e.g., resulting in a set of coefficients for the given test, each ranging from 0, for no intersection, to 1, for total intersection). Then, the coefficients generated for each of the tests may be used to cluster the tests (e.g., using a clustering algorithm). While this description focuses on an embodiment in which a coefficient is generated between two data sets at a time (e.g., between the execution statuses of a first test, across multiple versions of source code 206, and the execution statuses of a second test, across the multiple versions of source code 206), it should be appreciated that a coefficient may be used between more than two data sets in some embodiments.

The coefficients may be used to cluster tests 210 using any type or form of clustering technique. In one example, tests 210 may be clustered, based on the coefficients generated for each test, using k-means clustering. In one such example, the clustering process may begin by initializing a set of cluster centroids (e.g., an initial set of representative points configured to serve as the center of a cluster). The initial set of cluster centroids may be selected in a variety of ways. In some examples, the initial set of cluster centroids (e.g., a designated number of centroids) may be randomly selected. After selecting the initial set of cluster centroids, each test within tests 210 may be assigned to its nearest centroid using the coefficients generated for the test (e.g., by comparing each coefficient of the test to each of the centroids and assigning the test to the centroid with which the coefficients are most similar). After assigning each test to its nearest centroid, the centroids may be updated (e.g., based on a mean similarity of the tests within each cluster). This updating may iterate until convergence, with tests being reassigned to clusters based on updated centroids in each iteration.

In an additional or alternative example, tests 210 may be clustered, based on the coefficients generated for each test, using hierarchical clustering. In one such example, each test within tests 210 may begin as its own cluster and these clusters may be iteratively merged based on similarity between the coefficients generated for each test. In one example, the threshold for merging clusters may represent a manually designated similarity threshold. Additionally, or alternatively, the threshold for merging clusters may be determined algorithmically using a statistical technique (e.g., via a dendrogram analysis). In some examples, clusters may be iteratively merged until a stopping criteria is met, such as a designated number of clusters having been generated.

In one embodiment, tests that never fail are excluded (e.g., are not included in a cluster and/or are not considered for inclusion in a culled test suite). Excluding such tests from a test set may save considerable time and resources, especially if a large number of tests never fail. In some implementations, tests that never fail may be flagged for review as such tests may not be accurately testing the underlying source code 206.

After clustering tests 210 into clusters 212, test selection software application 204 can designate, for a particular test cluster (e.g., each of the test clusters), a cluster-representative test (e.g., may designate cluster-representative test 216 for cluster 214) (e.g., as described at step 306 of FIG. 3). The cluster-representative test may represent a single test or multiple tests (e.g., a designated number of tests). Test selection software application 204 may select the cluster-representative test for the particular test cluster in a variety of ways. For example, test selection software application 204 may identify a centroid of the particular test cluster and select a test corresponding to the centroid as the particular test cluster's cluster-representative test. The centroid of a particular test cluster may be identified using any type or form of clustering technique. In some examples, the centroid may represent a most representative coefficient from all of the coefficients in the particular test cluster.

Test selection software application 204 can cluster any number of tests into any number of clusters. In one specific example, test suite 208 includes 13,000 tests, which are clustered into 15 clusters, each of which is represented by a single cluster-representative test, reducing the number of tests in a test set from 13,000 to 15.

Test selection software application 204 can use clusters 212 and the cluster-representative test (e.g., selected for each of the clusters) in a variety of ways. In some examples, test selection software application 204 can create a culled test suite 218 (e.g., that includes only a subset of the tests included in tests 210). Test selection software application 204 can configure culled test suite 218 to include, for a particular cluster (e.g., cluster 214), the particular cluster's cluster-representative test (e.g., cluster-representative test 216) and may exclude, for the particular cluster, one or more (e.g., each) of the particular cluster's tests that were not selected as the particular cluster's cluster-representative test. In some examples, culled test suite 218 in FIG. 2 may correspond to culled test suite 112 in FIG. 1.

In some examples, culled test suite 218 may be evaluated for its ability to accurately predict failures in a full nightly test run. For example, culled test suite 218 may be applied to modified source code 110 (e.g., during the day as a developer is making changes). Any changes that did not result in a predicted failure, but that did generate a failure in the full nightly test run, may then be used to generate an accuracy score for culled test suite 218 (e.g., based on a number and/or percentage of failures that were not accurately predicted). If the accuracy score falls below an accuracy threshold, the clustering process may be modified (e.g., by changing a number of clusters generated by the clustering process, a clustering technique used during the clustering process, etc.).

In some examples, the clusters (used to generate culled test suite 218) may be updated on a periodic basis. In one such example, the clusters may be updated on a daily basis using a sliding window of recent test results. For example, the clusters may be updated based on test results (e.g., generated by nightly runs) from a given most-recent period of time (e.g., the past seven days). In certain examples, clustered test results may be used to diagnose the root cause of failures (e.g., determining that a change to financial aid code caused tests to fail in time tracking code).

In some examples (e.g., at step 308 described in FIG. 3), culled test suite 218 may be configured to be used by a developer to test the developer's code locally (e.g., in real-time as the developer is developing the code). In one such example, the clusters used for culled test suite 218 may be updated in real-time based on (1) the list of tests relating to areas of base code predicted to be affected by the changes applied to the base code by the developer and/or (2) recent test results (e.g., from a given most-recent period of time).

In some examples (e.g., in addition to culling based on correlational data), test selection software application 204 can cull data based on failure data. For example, test selection software application 204 can (1) determine which tests from test suite 208 are most likely to predict failure during a nightly build and (2) include the determined test in culled test suite 218.

Details of the foregoing components are next described more fully with respect to the following flow diagrams. The steps shown in these flow diagrams may be performed by any suitable computer-executable code and/or computing system, including the system(s) illustrated in FIGS. 1 and 2. For example, the steps shown in these flow diagrams may be performed by modules operating in a server and/or modules operating in a client device. In one example, one or more of the steps may represent an algorithm whose structure includes and/or is represented by multiple sub-steps.

FIG. 3 is a flow diagram illustrating a method 300 for clustering tests within a test suite. A detailed description of the features corresponding to the steps of FIG. 3 are provided in connection with FIGS. 1 and 2. That description is not repeated herein in its entirety but is incorporated in its entirety.

In step 302, the method can include executing, by a processor on a collection of source code (e.g., source code 206 in FIG. 2), a test suite (e.g., test suite 208 in FIG. 2) that includes multiple tests (e.g., multiple tests 210).

In this step, a test suite containing multiple tests is executed on a collection of source code. The source code may represent an entire codebase or multiple versions of the source code captured at different intervals within a designated time window. For example, the source code may include daily captures of the codebase over the past week. The test suite is then executed on each of these versions of the source code.

In step 304, the method can include clustering, by the processor based on a result of executing the test suite, the multiple tests into multiple test clusters (e.g., test clusters 212 in FIG. 2). As described in connection with FIG. 2, the multiple tests can be clustered using any type or form of clustering process.

In this step, the multiple tests are clustered into multiple test clusters based on the results of executing the test suite on the collection of source code. The clustering can be performed using various techniques, such as similarity metrics that quantify the similarity between tests. One approach is to cluster tests based on the co-variance between their execution statuses (e.g., failure statuses) across the multiple versions of the source code. Tests that fail together above a certain threshold may be clustered together.

Another method for clustering tests is to use a coefficient, such as the Jaccard similarity coefficient, which measures the size of the intersection between the execution statuses of the tests. For each test, a set of coefficients is generated, denoting the intersection between its execution statuses and those of the other tests across the multiple versions of the source code. These coefficients, ranging from 0 (no intersection) to 1 (total intersection), are then used to cluster the tests using a clustering algorithm like k-means or hierarchical clustering.

In the k-means clustering approach, a set of cluster centroids is initialized, and each test is assigned to its nearest centroid based on the generated coefficients. The centroids are then updated based on the mean similarity of the tests within each cluster, and the process iterates until convergence, with tests being reassigned to clusters in each iteration.

Hierarchical clustering, on the other hand, starts with each test as its own cluster and iteratively merges clusters based on the similarity between the coefficients of the tests. The merging threshold can be manually designated or determined algorithmically using statistical techniques like dendrogram analysis. Clusters are merged until a stopping criterion, such as a desired number of clusters, is met.

In step 306, the method can include designating, by the processor for a particular test cluster within the multiple test clusters, a cluster-representative test (e.g., cluster-representative test 216 for cluster 214 in FIG. 2).

In this step, a cluster-representative test is designated for each of the test clusters generated in the previous step. The cluster-representative test serves as a representative for all the tests within its respective cluster and can be used to create a culled test suite that includes only a subset of the original tests.

The selection of the cluster-representative test can be done in various ways. One approach is to identify the centroid of each test cluster and select the test corresponding to that centroid as the cluster-representative test. The centroid represents the most representative point or coefficient within the cluster and can be determined using clustering techniques such as calculating the mean or average of all the coefficients in the cluster.

For example, consider a test cluster containing one hundred tests. By analyzing the coefficients of these tests, which were generated based on their execution statuses across multiple versions of the source code, the centroid of the cluster can be identified. The test that corresponds to this centroid, i.e., the test whose coefficient is closest to the centroid, is then selected as the cluster-representative test for that particular cluster.

In some implementations, this process is repeated for each test cluster, resulting in the designation of a cluster-representative test for every cluster. These cluster-representative tests will be used to create the culled test suite, which aims to reduce the number of tests that need to be executed while still maintaining the effectiveness of the testing process.

In some implementations, the cluster-representative test may not always be a single test; in some cases, multiple tests (e.g., a designated number of tests) can be selected to represent a cluster. The specific approach used to select the cluster-representative test(s) may vary depending on the requirements and characteristics of the software development project.

In step 308, the method can include executing, by the processor on a subsequent collection of source code (e.g., modified source code 110 in FIG. 1), a culled test suite (e.g., culled test suite 112 in FIG. 1 and/or culled test suite 218 in FIG. 2) that includes the particular test cluster's cluster-representative test and that excludes one or more tests of the particular test cluster that were not designated as the particular test cluster's cluster-representative test.

In this step, the culled test suite, which was created using the cluster-representative tests, can be executed on a subsequent collection of source code, such as modified source code that includes changes made by developers. The culled test suite can include the cluster-representative test from each cluster and excludes the tests that were not selected as representative for their respective clusters.

By running the culled test suite on the modified source code, the testing process becomes more efficient and targeted. Instead of executing the entire original test suite, which could be time-consuming and resource-intensive, only the representative tests from each cluster are run. This approach allows for quicker feedback on the impact of the code changes while still maintaining a high level of test coverage. For example, suppose the original test suite contains 1,000 tests, and after clustering, 20 clusters are formed, each represented by a single cluster-representative test. The culled test suite, in this case, would consist of only these 20 representative tests. When developers make changes to the source code, the culled test suite is executed on the modified code, providing faster insights into potential issues or regressions introduced by the changes.

In some implementations, the execution of the culled test suite on the modified source code can be performed in various contexts, such as during continuous integration or as part of a developer's local testing process. By incorporating the culled test suite into the development workflow, teams can quickly identify, and address issues related to the code changes, enabling faster iterations and reducing the risk of introducing bugs or regressions.

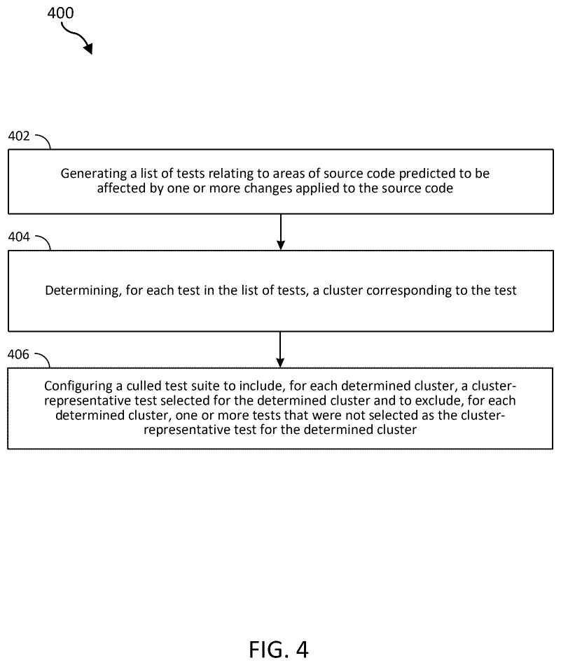

FIG. 4 is a flow diagram illustrating a method 400 for executing a culled test suite on source code. A detailed description of the features corresponding to the steps of FIG. 4 are provided in connection with FIGS. 1 and 2. That description is not repeated herein in its entirety but is incorporated in its entirety.

In step 402, the method can include generating a list of tests relating to areas of source code predicted to be affected by one or more changes applied to the source code.

In this step, a list of tests is generated based on the areas of the source code that are predicted to be affected by the changes made to the code. This list of tests is derived from the analysis of the code changes and their potential impact on the existing codebase.

The process of generating the list of tests involves examining the modifications made to the source code and identifying the specific areas or components that are likely to be influenced by these changes. This can be achieved through various techniques, such as static code analysis, dependency analysis, or utilizing existing knowledge about the system's architecture and inter-component relationships.

For example, if a developer modifies a particular function or module within the source code, the system can analyze the dependencies and relationships of that function or module with other parts of the codebase. Based on this analysis, it can identify the tests that are relevant to the modified code and its associated components.

In step 404, the method can include determining, for each test in the list of tests, a cluster corresponding to the test (e.g., a cluster from a set of clusters generated for a test suite such as clusters 212 in FIG. 2).

In this step, each test from the list of tests generated in the previous step is mapped to its corresponding cluster. The clusters used in this step are the same clusters that were created earlier by clustering a test suite based on test execution results.

To determine the cluster for each test, the system compares the characteristics or attributes of the test with the properties of the existing clusters. This comparison can be based on various factors, such as the test's execution history, its coverage of specific code components, or its similarity to other tests within the clusters.

For example, if a test from the list of tests has a similar execution history and covers similar code components as the tests in a particular cluster, it would be mapped to that cluster. This mapping process helps identify the cluster that best represents each test from the list of tests.

The mapping of tests to clusters can be performed using different techniques, depending on the clustering algorithm and the available data. Some common approaches include similarity-based mapping, rule-based mapping, and machine-learning mapping. Once each test from the list of tests is mapped to its corresponding cluster, the system can proceed to the next step of configuring the culled test suite based on the cluster-representative tests.

In step 406, the method can include configuring a culled test suite (e.g., that includes a subset of the tests included with the test suite described at step 404) to include, for each determined cluster, a cluster-representative test selected for the determined cluster and to exclude, for each determined cluster, one or more tests that were not selected as the cluster-representative test for the determined cluster.

In this step, a culled test suite is configured based on the cluster-representative tests determined in the previous steps. The culled test suite is a subset of the original test suite and aims to reduce the number of tests that need to be executed while still maintaining effective test coverage.

In some implementations, the configuration of the culled test suite involves the following process. For each cluster identified in step 404, the corresponding cluster-representative test is included in the culled test suite. The cluster-representative test is selected to represent all the tests within its respective cluster and is considered sufficient for testing the functionality covered by that cluster. For each cluster, the tests that were not selected as the cluster-representative test are excluded from the culled test suite. These tests are considered redundant or less critical for the current testing scenario, as the cluster-representative test is expected to cover the essential aspects of the cluster. In this approach, the culled test suite is constructed to include only the cluster-representative tests from each cluster, while excluding the remaining tests within each cluster. This selective inclusion and exclusion of tests based on their cluster representation helps to create a streamlined and efficient test suite.

The resulting culled test suite contains a reduced number of tests compared to the original test suite, as it includes only one representative test per cluster. This reduction in the number of tests can significantly improve the efficiency of the testing process, as fewer tests need to be executed, leading to faster feedback cycles and reduced resource consumption.

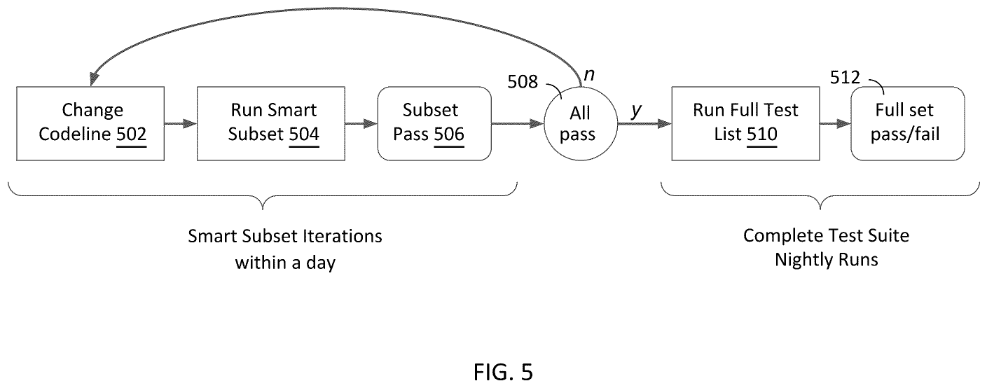

FIG. 5 is a flow diagram illustrating an exemplary process in which both a full test set (e.g., test suite 208 in FIG. 2) and a culled test suite (e.g., culled test suite 112 in FIG. 1) are used.

In step 502, changes are made to a line of code (e.g., modified source code 110). In this step, changes are made to a line of code, which represents a specific version or branch of the source code. These changes can include modifications, additions, or deletions of code, and they are typically made by developers working on the codebase. Once the changes to the code are complete, the modified source code is typically submitted for testing and integration with the main codebase.

To receive a quick turn-around early indicator of pass/fail iterations, in step 504 a developer may submit the changed codeline for testing by a smart subset (e.g., culled test suite 112) of a fuller test suite (e.g., test suite 208).

In this step, the developer submits the changed line of code, which includes the modifications made in step 502, for testing using a subset of the full test suite. The culled test suite, as described in the previous steps, is created by selecting representative tests from each cluster of the full test suite. By focusing on a smaller set of tests, the culled test suite allows for faster execution and feedback compared to running the entire test suite. The selection of tests for the culled suite is based on factors such as code coverage, historical test results, and the specific areas of the codebase impacted by the changes. If the culled test suite reveals any failures, the developer can investigate and address those issues before proceeding further. On the other hand, if the culled test suite passes, it provides an initial level of confidence that the changes are not introducing obvious regressions or breaking existing functionality.

In step 506, a subset of the tests may pass (and another subset may fail). In step 506, the culled test suite is executed on the changed line of code, and the results are analyzed. Based on the test execution, a subset of the tests may pass, indicating that the corresponding functionality is working as expected, while another subset of tests may fail, suggesting the presence of issues or regressions introduced by the changes.

In step 508, if one or more fail, the flow may return to step 502 (after the developer has made additional changes to resolve the failure). In step 508, if one or more tests from the culled test suite fail, the flow returns to step 502. This indicates that the developer needs to make further modifications to the code to address the identified issues before resubmitting the changed line of code for testing.

If all pass, the changed codeline may be retested (e.g., at a later time) with a full test list (e.g., test suite 208) in step 510 and a full set of pass and fail statuses may be determined in step 512.

In step 510, if all tests from the culled test suite pass successfully, the changed line of code progresses to the next stage of testing. At this point, the line of code is retested using the full test suite, which includes a comprehensive set of tests covering a wider range of scenarios and edge cases compared to the culled test suite. The execution of the full test suite provides a more thorough evaluation of the changed line of code. It helps identify any issues or regressions that may have been missed by the culled test suite, ensuring a higher level of confidence in the quality and reliability of the changes.

In step 512, the results of executing the full test suite on the changed codeline are analyzed. This analysis involves examining the pass and fail statuses of all the tests in the suite. If any tests fail during this stage, it indicates that there are still issues present in the changed line of code that need to be addressed by the developer. The full test suite execution helps uncover more subtle or complex problems that may not have been detected by the culled test suite. It provides a comprehensive assessment of the changed line of code's behavior and compatibility with the existing codebase. Based on the results of step 512, the developer can take appropriate actions. If all tests pass, it suggests that the changes are stable and can be considered for integration into the main codebase. However, if any tests fail, the developer needs to investigate and resolve the identified issues before proceeding further.

In some examples, steps 502-508 may be performed iteratively throughout the day and step 510-512 may be performed at set intervals (e.g., as part of nightly runs).

The framework described herein may reduce or eliminate the number of code failures caused in a variety of scenarios. For example, the disclosed framework may reduce or eliminate the number of code failures caused by a conflict between two separate collections of source code (e.g., generated by two different developers) when the two separate collections of source code are applied to a same base code. As another example, the disclosed framework may reduce or eliminate the number of code failures caused when a collection of source code (e.g., a single collection of source code generated by a single developer) is applied to a base code (e.g., in scenarios in which a size of the collection of source code makes it prohibitive to run each test predicted, using traditional frameworks, to be affected by the changes to the base code in the collection of source code).

FIG. 6 is a block diagram of a computing device according to some embodiments of the disclosure.

As illustrated, the device includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
executing, by a processor on a collection of source code, a test suite comprising a plurality of tests;
clustering, by the processor based on a result of executing the test suite, the plurality of tests into a plurality of test clusters;
designating, by the processor for a particular test cluster within the plurality of test clusters, a cluster-representative test; and
executing, by the processor on a subsequent collection of source code, a culled test suite, the culled test suite comprising a subset of the plurality of tests including the particular test cluster's cluster-representative test.

2. The method of claim 1, wherein:
the collection of source code comprises a plurality of versions of the collection of source code, each of which is captured at a different interval within a designated window of time; and
executing the test suite on the collection of source code comprises executing the test suite on each version within the plurality of versions.

3. The method of claim 2, wherein clustering the plurality of tests into the plurality of test clusters comprises clustering the plurality of tests based on a similarity metric quantifying a similarity between the plurality of tests.

4. The method of claim 3, wherein the similarity quantified by the similarity metric relates to co-variance between execution statuses of the plurality of tests when executed across the plurality of versions of the collection of source code.

5. The method of claim 1, further comprising selecting, by the processor, a test to be designated as the particular test cluster's cluster-representative test, wherein selecting the test comprises:
identifying the test as a centroid of the particular test cluster; and
selecting the test as the cluster-representative test for the particular test cluster in response to identifying the test as the centroid of the particular test cluster.

6. The method of claim 1, wherein:
the subsequent collection of source code comprises a base code and one or more changes applied to the base code; and
executing the culled test suite on the subsequent collection of source code comprises:
generating a list of tests relating to areas of the base code predicted to be affected by the one or more changes applied to the base code;
determining, for each test within the list of tests, a cluster corresponding to the test; and
configuring the culled test suite to include, for each determined cluster, a cluster-representative test selected for the determined cluster and to exclude, for each determined cluster, one or more tests that were not selected as the cluster-representative test for the determined cluster.

7. The method of claim 6, wherein generating the list of tests relating to the areas of the base code predicted to be affected by the one or more changes comprises:
applying the subsequent collection of source code as input to an impact analysis tool; and
generating the list of tests based on an output from the impact analysis tool.

8. The method of claim 6, further comprising:
determining, by the processor, that applying the culled test suite to the subsequent collection of source code did not yield any test failures;
merging, by the processor, the subsequent collection of source code that comprises the base code and the one or more changes to the base code, with an additional subsequent collection of source code, the additional subsequent collection of source code comprising the base code and one or more additional proposed changes to the base code;
executing, by the processor, an additional culled test suite to the merged collection of source code;
determining, by the processor, that applying the additional culled test suite to the merged collection of source code yielded one or more test failures; and
in response to determining that executing the culled test suite to the subsequent collection of source code did not yield any test failures and that applying the additional culled test suite to the merged collection of source code yielded one or more test failures, determining, by the processor, that a conflict exists between the one or more proposed changes to the base code and the one or more additional proposed changes to the base code.

9. A non-transitory computer-readable storage medium for tangibly storing computer program instructions capable of being executed by a computer processor, the computer program instructions defining steps of:
executing, on a collection of source code, a test suite comprising a plurality of tests;
clustering, based on a result of executing the test suite, the plurality of tests into a plurality of test clusters;
designating, for a particular test cluster within the plurality of test clusters, a cluster-representative test; and
executing, on a subsequent collection of source code, a culled test suite, the culled test suite comprising a subset of the plurality of tests including the particular test cluster's cluster-representative test.

10. The non-transitory computer-readable storage medium of claim 9, wherein:
the collection of source code comprises a plurality of versions of the collection of source code, each of which is captured at a different interval within a designated window of time; and
executing the test suite on the collection of source code comprises executing the test suite on each version within the plurality of versions.

11. The non-transitory computer-readable storage medium of claim 10, wherein clustering the plurality of tests into the plurality of test clusters comprises clustering the plurality of tests based on a similarity metric quantifying a similarity between the plurality of tests.

12. The non-transitory computer-readable storage medium of claim 11, wherein the similarity quantified by the similarity metric relates to co-variance between execution statuses of the plurality of tests when executed across the plurality of versions of the collection of source code.

13. The non-transitory computer-readable storage medium of claim 9, the computer program instructions further defining a step of selecting a test to be designated as the particular test cluster's cluster-representative test, wherein selecting the test comprises:
identifying the test as a centroid of the particular test cluster; and
selecting the test as the cluster-representative test for the particular test cluster in response to identifying the test as the centroid of the particular test cluster.

14. The non-transitory computer-readable storage medium of claim 9, wherein:
the subsequent collection of source code comprises a base code and one or more changes applied to the base code; and
executing the culled test suite on the subsequent collection of source code comprises:
generating a list of tests relating to areas of the base code predicted to be affected by the one or more changes applied to the base code;
determining, for each test within the list of tests, a cluster corresponding to the test; and
configuring the culled test suite to include, for each determined cluster, a cluster-representative test selected for the determined cluster and to exclude, for each determined cluster, one or more tests that were not selected as the cluster-representative test for the determined cluster.

15. The non-transitory computer-readable storage medium of claim 14, wherein generating the list of tests relating to the areas of the base code predicted to be affected by the one or more changes comprises:
applying the subsequent collection of source code as input to an impact analysis tool; and
generating the list of tests based on an output from the impact analysis tool.

16. The non-transitory computer-readable storage medium of claim 14, the computer program instructions further defining the steps of:
determining that applying the culled test suite to the subsequent collection of source code did not yield any test failures;
merging the subsequent collection of source code, comprising the base code and the one or more changes to the base code, with an additional subsequent collection of source code, wherein the additional subsequent collection of source code comprises the base code and one or more additional proposed changes to the base code;
executing an additional culled test suite to the merged collection of source code;
determining that applying the additional culled test suite to the merged collection of source code yielded one or more test failures; and
in response to determining that executing the culled test suite to the subsequent collection of source code did not yield any test failures and that applying the additional culled test suite to the merged collection of source code yielded one or more test failures, determining that a conflict exists between the one or more proposed changes to the base code and the one or more additional proposed changes to the base code.

17. A device comprising:
a processor; and
a storage medium for tangibly storing thereon program logic for execution by the processor, the program logic comprising:
logic, executed by the processor, for executing a test suite comprising a plurality of tests,
logic, executed by the processor, for clustering, based on a result of executing the test suite, the plurality of tests into a plurality of test clusters,
logic, executed by the processor, for designating, for a particular test cluster within the plurality of test clusters, a cluster-representative test, and
logic, executed by the processor, for executing, on a subsequent collection of source code, a culled test suite, the culled test suite comprising a subset of the plurality of tests including the particular test cluster's cluster-representative test.

18. The device of claim 17, wherein:
the collection of source code comprises a plurality of versions of the collection of source code, each of which is captured at a different interval within a designated window of time; and
executing the test suite on the collection of source code comprises executing the test suite on each version within the plurality of versions.

19. The device of claim 18, wherein clustering the plurality of tests into the plurality of test clusters comprises clustering the plurality of tests based on a similarity metric quantifying a similarity between the plurality of tests.

20. The device of claim 19, wherein the similarity quantified by the similarity metric relates to co-variance between execution statuses of the plurality of tests when executed across the plurality of versions of the collection of source code.
